(19) United States
(12) Patent Application Publication
(10) Pub. No.: US 2019/0111565 A1
(43) Pub. Date: Apr. 18, 2019

(54) ROBOT TRAINER

(71) Applicant: True Systems, LLC, Fairfield, NJ (US)

(72) Inventors: Douglas Winston Hines, Lincoln Park, NJ (US); Mark Shaffer Annett, Livingston, NJ (US)

(73) Assignee: True Systems, LLC, Fairfield, NJ (US)

(21) Appl. No.: 15/785,713

(22) Filed: Oct. 17, 2017

(51) Int. Cl. B25J 11/00

(52) U.S. Cl. CPC B25J 11/001

(57) ABSTRACT

The present disclosure describes a robotic training system designed to simulate the behavior of humans, animals and even machines and is not only able to receive both physical and non-physical input from a user interacting with it but the robot also has the ability to transmit a response back to the user that is indicative of an emotional response consistent with a programed personality profile.

The robot training system has one or more emotional state, including training states, and will transition from one of the training to either another training state or a different emotional state when a transition point to be reached, the input upper limit is exceeded, or the input lower limit is crossed at which point the system may also switch to a different personality profile.

The robot training system may further comprise an uncanny response limit above which the system prioritizes not being wrong over delivering a correct answer.

### PRIORITY

NA

### FIELD

The present application relates robots and specifically related to robots capable of producing emotional and physical responses.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND

There are tasks and skills that involve physical and emotional interactions with other human beings (or animals). For instance, a massage therapist involves touching a massage client. Normally, a massage will just involve therapeutic touch but everything can change if the client becomes, or shows signs of becoming sexually aroused during the massage. In massage schools, they often provide students with guidance about what to do in this type of situation. Techniques can involve taking a break, having a conversation with the client that this can be a normal physical reaction and even applying physical pressure to just below the point of physical pain. The question becomes how do you realistically train someone in these types of physical situations, which may never occur during training. Some behaviors, such as sexual arousal, which involve an emotional and physical reaction, just cannot be faked. As a result, crucial training is simply provided as book learning, because, when using human beings in such situations, it is either impossible to produce the desired emotional and physical response on demand or it may involve putting one or both of the individuals involved at unnecessary risk.

For example, a convicted rapist may have never had a normal physical relationship with another but desire to learn how to do so. To place an actual human being in this particular type of training situation may involve substantial risk to the trainer. At the other end of the spectrum, a victim of rape may desire to return to a level of health sexual activity but may be terrified of being alone with someone of the same gender as his/her rapist. However, they may still have a desire to practice normal dating behavior in a controlled fashion.

Therefore, there continues to be a need for individuals to be able to practice and/or experience real world situations that would typically involve a physical and emotional interaction with another person (or animal) but it is either not safe to do so or the desired emotional physical interaction cannot be produced on demand, as required.

### SUMMARY

In order to overcome the deficiencies in the prior art, systems and methods are described herein.

One aspect of the claimed invention involves an interaction training system comprising: a robot with one or more processors capable of processing computer code, one or more interaction interfaces configured to receive input, one or more output systems configured to transmit a response, one or more personality profiles, and at least two or more emotional states, wherein the system is configured to transition between the at least two or more emotional states.

A further aspects involves wherein at least one of the emotional states is a first training state having an upper lower input thresholds and a predetermined training criteria; and wherein the system is configured transition out of the first training state to another emotional state when one of the following occurs: the upper input threshold is exceed, the input received drops below the lower input threshold, the input has remained between the first upper and first lower threshold until the predefined training criteria has been met.

Another further aspect involves the system further comprising a predetermined uncanny response limit that the system uses to prioritize not being wrong the closer the user's perceived emotional response is to, or above, the uncanny response limit.

Another aspect involves a method of producing interaction in a robotic training system comprising establishing an initial emotional state and personality; determining, based on received user input, an emotional state to be tied to the output response and producing an output response associated with the determined emotional state and current personality profile.

A further aspects of the method involves the robotic system having at least two emotional states of which one of the emotional states is a training state having an upper input threshold, a lower input threshold, and a predefined training criteria and transitioning between out of the training state when one of the following occurs: the upper input threshold is exceed, the input received drops below the lower input threshold, or the predefined training criteria has been met.

Another further aspect of the method involves the system further comprising a predetermined uncanny response limit and prioritizing not being wrong the closer the user's perceived emotional response is to, or above, the uncanny response limit.

These and other aspects described herein present in the claims result in features and/or can provide advantages over current technology.

The advantages and features described herein are a few of the many advantages and features available from representative embodiments and are presented only to assist in understanding the invention. It should be understood that they are not to be considered limitations on the invention as defined by the claims, or limitations on equivalents to the claims. For instance, some of these advantages or features are mutually exclusive or contradictory, in that they cannot be simultaneously present in a single embodiment. Similarly, some advantages are applicable to one aspect of the invention, and inapplicable to others. Thus, the elaborated features and advantages should not be considered dispositive in determining equivalence. Additional features and advantages of the invention will become apparent in the following description, from the drawings, and from the claims.

### DRAWINGS-FIGURES

FIG. 1 shows, in simplified form, a representative system;

FIG. 2 shows, in simplified form, a block diagram representing a personality profile;

FIG. 3 shows, in simplified form, an emotional state diagram comprising emotional states S1, S2, S3, S4, and Sn;

FIG. 4, shows in simplified form, a graph of input verses time for training states;

FIG. 5 shows, in simplified form, a graph showing consistency of response and emotional response.

FIG. 6 shows, in simplified form, a method consistent with the present embodiments.

### DETAILED DESCRIPTION

This disclosure provides a technical solution to address the problem of how to create a physical interaction system that simulates human, animal, or machine responses that involve both an emotional and physical interaction that can be used for both daily interactions with human beings (or other devices/robots) as well as specialty training sessions.

Such a system comprises: a physical form (a robot) that is not only able to receive both physical and non-physical input from a user interacting with it but the robot also has the ability to transmit a response back to the user that is indicative of an emotional response consistent with a programed personality profile.

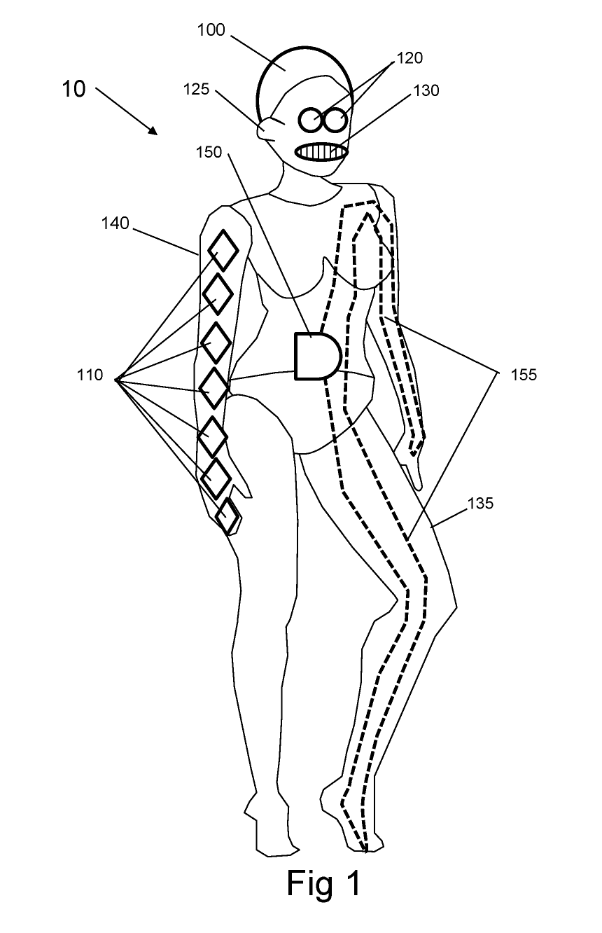

FIG. 1 shows, in simplified form, a representative system. The system is represented as an anthropomorphic robot 10, but could have been any physical form, such as an animal or machine that represents an actual form that a user (or other device/robots) might desire to interact with and expect to receive a response back from. Wherein the response is consistent with a personality profile and indicates an emotional response and/or physical response. The robot 10 utilizes one or more processors 100 configured to store data and to receive and process computer readable program instructions (computer code), in order to carry out aspects of the present invention. Specifically, the one or more processors, in conjunction with the computer code, are configured to process physical input received from the one or more physical interaction interfaces 110; process non-physical input received from the one or more non-physical interaction interfaces 120, 125; determine how the robot will respond to one or more of either the physical input or the non-physical; and transmit a response using one or more output systems 130, 135 to the user interacting with the robot 10.

The physical interaction interfaces 110 are represented in FIG. 1 as a series of sensor inputs along the right arm 140 of the robot 10. The one or more physical interaction interfaces 110 may be interconnected to form a matrix or be individually processed by the processor 100. The physical interaction interfaces 110 can be any type of input device appropriate for the type of physical input to be received. A non-exhaustive list of sensors that the one or more physical interaction interfaces 110 might employ includes capacitive, inductive, pressure, temperature, moisture, chemically reactive (e.g. to tastes such as saltiness) or a combination of one or more of the above. The important aspect not being the particular type of sensor employed by the physical interaction interfaces 110 but that the one or more physical interaction interfaces 110 are configured to receive the desired physical input. Additionally, the one or more physical interaction interfaces 110 can be located anywhere within or on the robot 10 where it is appropriate to receive the desired physical input, including external surfaces and internal orifices (e.g. such as the mouth, ear, anus, and vagina in the case of an anthropomorphic form).

The one or more non-physical interaction interfaces 120, 125 are represented as being associated with one or more of the ability receive visual as well as auditory input (including spoken language) and may comprise a camera and a microphone respectively. Similarly, the one or more non-physical interaction interfaces may be interconnected to form a matrix or be individually processed by the processor 100. For example, bi-lateral (or triangulated) auditory input is useful because based on signal delays the location of the auditory input can be determined and the robot can be configured to look in the direction that the auditory input is coming from.

The non-physical interaction interfaces 120, 125 can be any type of input device appropriate for the type of non-physical input to be received. A non-exhaustive list of additional input devices for include infrared detectors for measuring temperature of non-contacting bodies chemically reactive (e.g. to detect smells such as the release of pheromones), or a combination of one or more of the above. The important aspect being not the particular type of sensor employed by the one or more non-physical interaction interfaces 120, 125 but that the one or more non-physical interaction interfaces 120, 125 are configured to receive the desired non-physical input.

Additionally, the one or more non-physical interaction interfaces 120, 125 can be located anywhere within or on the robot 10 where it is appropriate to receive the desired physical input including external surfaces and internal orifices (e.g. such as the mouth, ear, anus, and vagina in the case of an anthropomorphic form).

The one or more output systems 130, 135 are represented as being associated with one or more of the ability produce auditory output 130 and physical movement 135. It is officially noted that the field of animatronics is well known in the art and includes the ability to produce a particular preprogrammed physical position and/or motion of the robot 10 and/or a pre-programmed auditory response.

However, while it is well known in the field of animatronics that a particular preprogrammed physical position and/or motion (including detailed facial expressions) of the robot 10 and/or a pre-programmed auditory response can be produced through a combination of actuators (inclusive of speakers), determining what the appropriate response to transmit back to the user that simulates human (or animal) responses that involve both an emotional and physical interaction requires more than just animatronics.

Additionally, while the field of animatronics involves preprogrammed physical position and/or motions and/or a pre-programmed auditory responses, which are appropriate for many situations, in training situations, related to physical and emotional interactions, these may be inappropriate to convey the appropriate physical and emotional interaction. In some cases, in order to display the desired physical and emotional interaction simulated physiological responses are needed.

For example, during a simulated dating situation, the heart rate, body temperature, and breathing may all begin to rise as excitement grows. By combining a circulating pump 150 and a fluid path 155 throughout the robot 10 then a pulse can be simulated. Further, if the pump 150 also comprises a heating element then changes in body temperature can also be simulated. In a similar manner, the pump 150 could circulate or pump air into an inflatable bladder within the chest cavity of the robot that could simulate breathing. It is worth noting that the simulated breathing is particularly effective if an air pathway (not shown) used to inflate/deflate the bladder is connected to an oral or nasal orifice. Moreover, as excitement continues to grow, simulation of additional physiological responses may be desirable such as pupil dilation, which may be simulated by using a mechanical aperture that opens and closes; the release of scents/pheromones, which may be accomplished by use of an electrically actuated atomizer; the release of body fluids (e.g. sweat, tears, saliva or associated with other mucus membranes), which may be simulated by pumping an appropriate fluid from a reservoir to the appropriate body location; and even a male erection through the use of an actuator.

The above are only a few of the physiological responses possible. Other physiological changes that may be simulated include changes to the color or texture (goose bumps) of the robots exterior surface, which may be simulated for example by heating small expandable air pockets under the skin to create bumps on the surface or placing chemicals in the skin that are heat reactive. The importance being not the particular physiological response but that the robot may be configured to produce an appropriate physiological response given the received physical and non-physical inputs received.

Having described the exemplary inputs and output in order to produce an appropriate simulated emotional and physical response, we will turn our intention to determining which particular response to produce.

In order to determine which response to produce it is desirable that the robot have a personality profile, which is herein defined as programmed response implemented within the computer code that determines how the robot will respond to one or more of either the physical input or the non-physical input based on the robot's current emotional state.

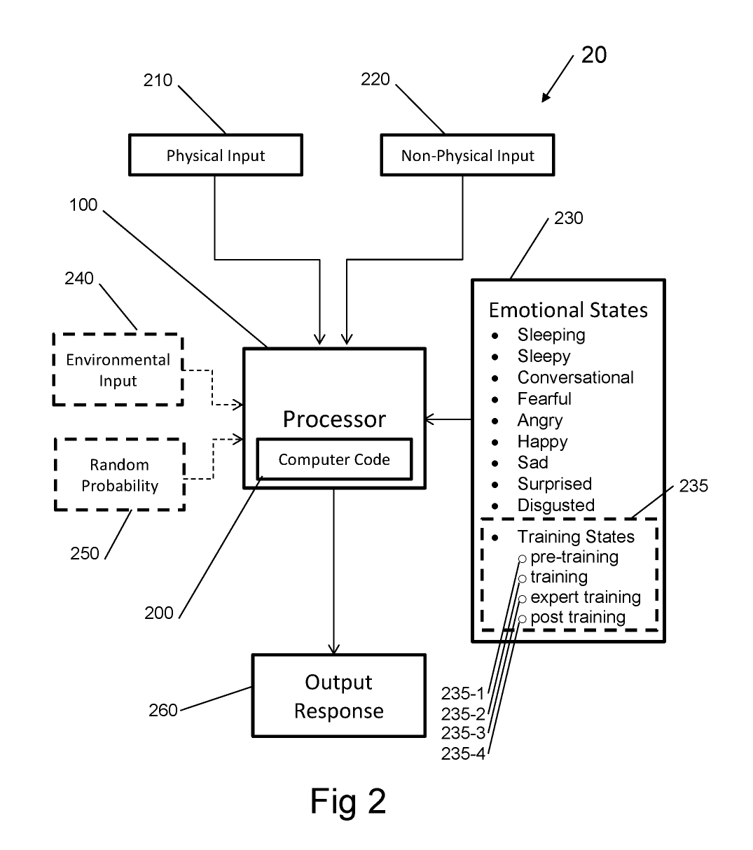

FIG. 2 shows, in simplified form, a block diagram representing a personality profile 20. It shows one or more processors 100, with computer code 200 that the processor 100 uses to both receive and process information related to one or more of physical input 210 on non-physical input 220, emotional state 230, and optionally environmental input 240 and/or random probability 250 in order to produce an output response 260.

Emotional states 230 can be tied to one or more of the physical input 210, the non-physical input 220, or the output response 240 but there must be at least two emotional states to provide differentiated interactions with a user. A non-exhaustive lists of emotional states 230 includes: sleeping, sleepy, conversational (non-specific state where input is being sought to determine a more definitive state), fearful, angry, happy, sad, surprised, disgusted and one or more training states 235, which will be discussed in more detail later.

For example, a gentle squeeze of the robot's hand (a physical input 210) could have one or more emotional states associated with it, for example happy or sad. In order to determine which one of these two states to assign to the behavior the processor 100 may utilize the non-physical input 220 in order to determine a context. For example, the non-physical input may come from a natural language processor, which is able process words, phrases, sentences in order to determine meaning. For instance, if the non-physical input includes the word “loss” then the non-physical input may be assigned the emotional state of “sad”.

[Note: often word parsing is not sufficient to assign an emotion state to a natural language input and it is often advantageous to use additional non-physical inputs such as the inflection, cadence, speed, and or volume of the input to provide a better emotional state assignment. For example if the phrase spoken was “If they have one more loss then we will make it into the playoffs!” may be reinterpreted as happy, based on the inflection, in spite of the word “loss”.]

As previously mentioned, an emotional state 230 may also be tied to the output response 260. An emotional state 230 assigned to the output response 260 may be determined based upon one or more of the following: the physical input 210, the non-physical input 220, previous emotional state assigned to the most recently produced output response 260, probability that emotion state 230 will occur based upon personality profile 20, environmental input (e.g. for example late at night or in a warm environment the emotional states of sleeping or sleepy are more probable), or a random probability.

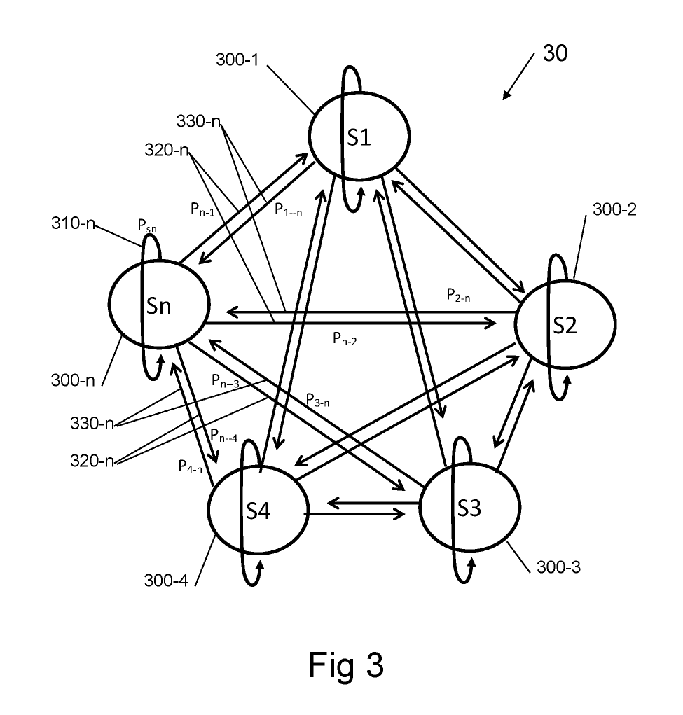

To understand the probability that a transitions between emotional states 230 will occur, it is helpful to examine an emotional state diagram. FIG. 3 shows, in simplified form, an emotional state diagram comprising emotional states S1, 300-1; S2, 300-2; S3, 300-3; S4, 300-4; Sn, 300-n. (Note: as previously stated at least two emotional states are necessary to provide differentiated interactions with a user.)

Each emotional state 300-1,300-2, 300-3, 300-4, 300-n has a probability Pₛₙ 310-n that it will remain in the same state. For example, if you are happy, you are likely to remain happy. The probability Pₛₙ 310-n for each emotional state 300-1,300-2, 300-3, 300-4, 300-n can be one or more of a fixed probability for a specific personality profile; dependent on the length of time in that particular emotional state 300-1,300-2, 300-3, 300-4, 300-n (e.g. if you are sad, for an extended period of time you are even more likely to remain sad); based on a random probability generator; or, as specified in FIG. 2, based on one or more of the previously mentioned physical 210, non-physical 220 and environmental 240 inputs.

Returning to FIG. 3, additionally, each emotional state 300-1, 300-2, 300-3, 300-4, 300-n has a probability P_{n-1,n-2,n-3,n-4} 320-n that it will transition to another emotional state and similarly a probability P_{1-n,2-n,3-n,4-n} 330-n that another emotional state will transition to it. For example, if you are fearful, you are more likely to transition to angry than you are to transfer to happy.

Probability P_{n-1,n-2,n-3,n-4} 320-n and probability P_{1-n,2-n,3-n,4-n} 330-n may be the same or different. Additionally each probability P_{n-1,n-2,n-3,n-4} 320-n and probability P_{1-n,2-n,3-n,4-n} 330-n may vary based upon one or more of the following: a specific personality profile; dependent on the length of time in that particular emotional state 300-1,300-2, 300-3, 300-4, 300-n; based on a random probability generator or, as specified in FIG. 2, based on one or more of the previously mentioned physical 210, non-physical 220 and environmental 240 inputs.

Having described the use of emotional states in general, it is useful to talk about the previously mentioned specialty emotional training states 235 of FIG. 2. Whereas typical emotional states involve the communication of emotions, training states involve the communication of skills and may be a mixture of the output responses 260 associated with one or more of the other emotional states 230 and/or have their own output responses 260 (or be a combination of both).

The training states can be further broken down into one or more of the following: pre-training 235-1, training 235-2, expert training 235-3, or post-training 235-4. For example, for someone who is interested in acquiring dating skills the pre-training 235-1 state may correspond to courting/pre-sexual states, the training 235-2 state may correspond to a sexually active/petting state, the expert training 235-3 state may correspond to a zenith/sexual climax state, and the post training 235-4 state may correspond to post sexual/cuddling state.

Other examples include training related to treatment of a particular disease. In this example, the pre-training 235-1 state may correspond to non-specific symptoms of feeling unwell, the training 235-2 state may correspond to a symptomatic state, the expert training 235-3 state may correspond to full-blown or critical state of the disease progression, and the post training 235-4 state may correspond to a recovery state.

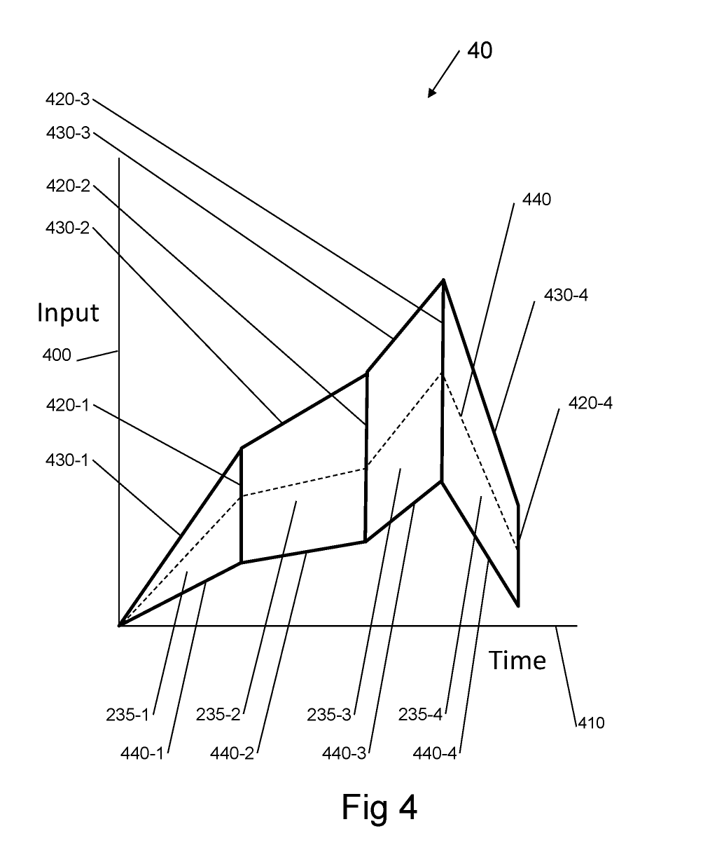

In addition to having specific emotional training states 235, it is also useful to establish input thresholds related to when one transitions from one training state 235 to another training state 235, which can be seen in FIG. 4.

FIG. 4, shows in simplified form, a graph 40 of input 400 verses time 410 for training states 235-1, 235-2, 235-3, 235-4. The graph 40 shows four representative training states 235-1, 235-2, 235-3, 235-4; however; a single training state is also possible or there could theoretically be an unlimited number of states (e.g. someone is being trained in theoretical physics). However, in practice, we have found that the previously mentioned four states: pre-training 235-1, training 235-2, expert training 235-3, or post-training 235-4 are applicable in most situations. Each training state 235-1, 235-2, 235-3, 235-4 has a transition point 420-1, 420-2, 420-3, 420-4 where a transition occurs form one training state to the next training state in the progression and will occur based on one or more of either a predetermined training criteria being met or on a probability of transition as previously discussed. Additionally, each training state 235-1, 235-2, 235-3, 235-4 has input upper limit 430-1, 430-2, 430-3, 430-4, which, if exceeded, a transition to an emotional state other than the next training state in the progression (e.g. fearful, angry, happy, sad, surprised, disgusted) will likely occur based on the previously described probability of transitions. Further, each training state 235-1, 235-2, 235-3, 235-4 has input lower limit 440-1, 440-2, 440-3, 440-4, which, if not reached, a transition to an emotional state other than the next training state in the progression (e.g. fearful, angry, happy, sad, surprised, disgusted) will likely occur based on the previously described probability of transitions. Finally, the graph shows a dashed line representing an idealized input curve 440 with respect to time, which may or may not be midway between the upper 430-1, 430-2, 430-3, 430-4 and lower limit lower limit 440-1, 440-2, 440-3, 440-4 for a particular training step.

As seen in the graph 40, the input thresholds can be individualized for each training state 235-1, 235-2, 235-3, 235-4 and the level of input (which can be from a single or combination of input sources) required to remain within the input thresholds can vary with time. In other embodiments, one or more of the training states can have the same input thresholds or one or more of the input thresholds could be constant with respect to time.

With respect to the transition points 420-1, 420-2, 420-3, 420-4, the graph 40 shows that the transition point 420-1, 420-2, 420-3, 420-4 occur after the level Input 400 has remained between the input upper limit 430-1, 430-2, 430-3, 430-4 and the input lower limit 440-1, 440-2, 440-3, 440-4 for a specific period of Time 410.

For example, returning to the person (or other devices/robots) who wants to practice dating behaviors and assuming for the moment that the robot is currently in the pre-training 235-1 courting/pre-sexual state. If the individual is too passive and does not proceed to appropriate physical input 210 such as handholding then the robot may transition to the conversational or possibly sleepy state. On the other hand, if the individual proceeds too fast and the physical contact it too aggressive (or the language too suggestive) then the robot may transition to the emotional states of fear or anger.

[Note: in the case where the individual through exceeding a threshold is (consciously or not) trying to solicit a particular reaction, such as fear or anger then typically the best option is returning to a conversational emotional state and ignoring responding to the to the unsolicited/inappropriate input. For example, with respect to the previously mentioned former rapist that is trying to learn appropriate dating behavior but begins to revert to previously learned undesirable behaviors. While it might be appropriate to transition to one of these emotions in a simulated dating training situation such as fear or anger, you would never want to continue with these emotional states, as rape is never a behavior that should be supported/simulated! While it is very unpleasant to think about such things, as mentioned in the background of this document, there continues to be a need for individuals (or machines) to be able to practice and/or experience real world situations that would typically involve a physical and emotional interaction with another person (or animal) but which are either not safe to do so or the desired emotional physical interaction cannot be produced on demand, as required. In the scenario just discussed, if the former rapist began to solicit fear or anger in a human trainer, it would be impossible for the human trainer to immediately transition to a conversational emotion state, as would be required to safely deescalate the situation. As undesirable as it is to discuss these topics, looking at unintended use/misuse of a system is often a necessary evil when developing a robust system.]

Returning to FIG. 4, physical time 410 is the typical increment used in determining when to make a transition to the next training state in the progression; however, in other embodiments counts of the number of times a specific type of input occurs can often be useful as well. In still other embodiments adherence to a process flow is used to determine when to transition to the next step. For example, in the previously mentioned courting/pre-sexual state the anticipated process flow might be: 1) provide a compliment, 2) ask to hold the persons hand, and 3) take the persons hand. If there is a deviation (a delta from the idealized input curve 440) such as the person moving too fast (e.g. taking the hand without asking first) or moves to slow (e.g. provides a compliment and then just sits there or talks about the weather) then that may cause the input to exceed either the upper 430-1, 430-2, 430-3, 430-4 or lower limit lower limit 440-1, 440-2, 440-3, 440-4 for a particular training step. The point being not the specific criteria utilized but that there is a predetermined criteria for transitioning to the next training state and if the predetermined criteria is met then a transition will occur.

It is worth noting that exceeding input upper limit 430-1, 430-2, 430-3, 430-4 or dropping below the input lower limit 440-1, 440-2, 440-3, 440-4 may or may not cause a transition out of the current training state 235-1, 235-2, 235-3, 235-4, as behavioral correction output responses can be built into the personality profile associated related to a particular input level and emotional state. It should also be noted that the upper and lower limit thresholds need not be static with time. As training progresses, it is often desirable that the input upper 430-1, 430-2, 430-3, 430-4 and lower limit 440-1, 440-2, 440-3, 440-4 be adjusted (either manually or automatically) so that they get closer and closer to the idealized input curve 440, as the individual becomes more of an expert at a particular training step.

It should also be noted that not only is it advantageous to be able to transition from one emotional state to another but it also useful to allow the ability to switch between personality profiles 20, if the robot includes more than one.

For example, within a training state different people may be more responsive to different personalities where one person may perform better when the training occurs from an authoritarian personality and another may be more successful with a cajoling or sympathetic personality.

For example, in training customer service representatives to deal with various customers, the robot may adopt various personalities (pleasant, hostile, confused . . . etc.) during the training phase and the representative will be graded on how they interact during each phase. However, when the user exceeds one the interaction limits and falls out the training mode (rather than advancing to the next training step) then often it is highly advantageous that different personality take over (e.g. an instructor personality) rather than the personality currently being trained, which might have been for example a hostile or confused personality.

Furthermore, it can also be advantageous to switch as the trainee advances from one training state to another. For example, returning to the previous example of an individual that wants to develop dating skills. The personality profile that the robot may start with could be user selectable or based on a user profile obtained in response to the physical 210 and non-physical 220 input supplied. For illustration purposes, assume the robot's initial personality profile (and the associated output responses) are that of a very shy and inexperienced partner. This personality profile may have very strict limits of what constitutes acceptable physical 210 and/or non-physical 220. However, just like in real life, assuming the user's inputs remain within the training state thresholds then it can be also advantageous to switch personality when transitioning between training states, such as to a more open and adventurous personality profile in the example of learning dating behavior.

In still other embodiments, it may be determined, based upon the user profile, that the individual has very low self-esteem and needs to achieve immediate success. In this particular case, a very sexually “wild” personality profile 20 with very open limits of what constitutes acceptable physical 210 and/or non-physical 220 may be selected, such that the individual will be highly likely to succeed. Over time (or with repeated use), the robot's personality profile would potentially proceed in the opposite direction towards a more constrained profile and thus allowing the behavioral principle of backward chaining to be utilized. [Note: In backward chaining, skills are learned by practicing the final skills first and then once you have mastered them proceed to the beginning earlier skills such that the skill is learned from end to beginning rather than beginning to end.]

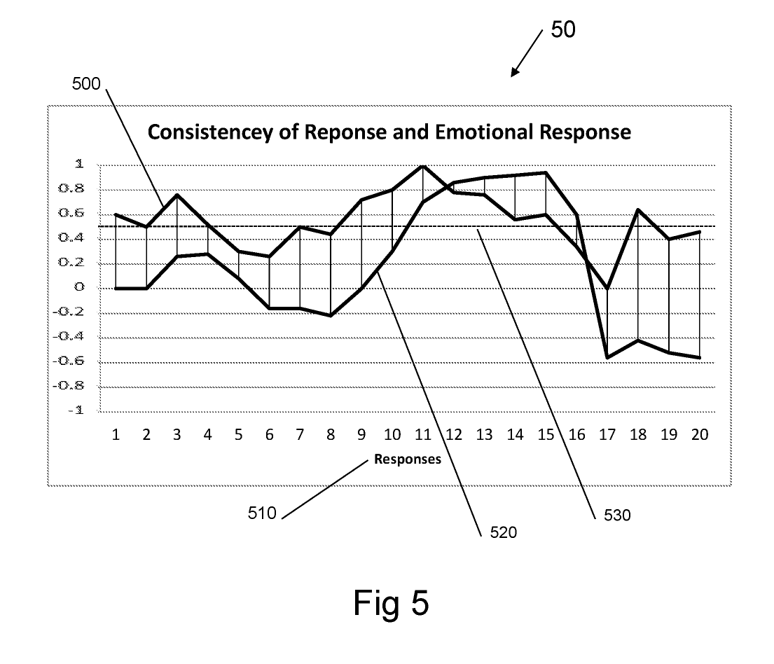

However, regardless of whether or not a personality profile has been implemented, we have discovered in our research that the concept of the “uncanny valley” (a phenomenon whereby a humanoid robot bearing a near-identical resemblance to a human being arouses a sense of unease or revulsion in the person viewing it) has a output response/interaction related corollary. The corollary that we have discovered is that the more the user begins to feel like they are truly interacting with a human (or animal) that the robot is simulating then the greater their negative emotional response is when the interaction with the robot is inconsistent with what a human (or animal) would do. A graphical representation of this phenomena will now discuss in more detail, using FIG. 5.

FIG. 5 shows, in simplified form, a graph 50 showing consistency of response 500 and emotional response 520. The consistency of response 500, is the perceived consistency of the responses 510 based on the perception of a user that the response would match that of a human being (or animal). In general, the higher the consistency of the response 500, the greater the emotional response 520 that the user feels towards the robot.

The graph 50 is shown with an illustrative vertical scale from −1 to 1 for both the consistency of response 500 and emotional response 520. With respect to the consistency of response 500: −1 represents a totally inconsistent response, 1 being perfectly consistency, and 0 being a response that elicits a neutral (or non-changing) emotional response 520 in the user. With respect to emotional response 520, 1 represents having a significant positive emotional attachment (e.g. love) for the robot and less than 0 being a negative attachment to the robot.

In the hypothetical example shown a new interaction is shown as initiating with the first output response 510. The consistency of this response 500 is estimated to be 0.6 and, as this is a new interaction, the user's emotional response 520 was, in this hypothetical example, started out as neutral (0). The second response 510 is even with the dashed line, which represents the uncanny response limit 530. The uncanny response limit 530 is the point at which the consistency or response 510 produces a neutral change in the emotional response 520 of the user. Above the uncanny response limit 530 the user has an increased emotional response 520 and below it the user has a decreased emotional response. What our research has shown is that the more neutral the emotional response to the user the less significant the impact of the consistency of the response being below the uncanny response limit 530 is; however, as the emotional response 520 grows, the more significant the impact of being below the uncanny response limit 530 becomes. As such, the greater the emotional response 520 being felt by the user the more important in becomes not to give a wrong response (below the uncanny response limit 530) to the user.

If the interactions of a robot are consistent with a human being (or animal), such that a user begins to develop a significant emotional response or connection to the robot, our research indicates that if the robot gives an output response that is suddenly inconsistent with a human being then the user may quickly fall into what we refer to as an uncanny-response valley.

When the user falls into the uncanny-response valley, depending on the user's level of emotional response 520 or connection to the robot, the user will often experience a complex series of involuntary emotions, such as fear or anger, when they are suddenly reminded of the fact that they are interacting with a robot and not a human being (or animal). Our research indicates that the greater level of emotional response 520 or connection to the robot by the user then typically the greater the emotional reaction or the deeper the valley that they may fall into.

However, the robot simply producing a single inconsistent output response typically does not mean that the user will immediately fall into the uncanny-response valley. Instead, falling into the uncanny-response valley usually involves a series on inconsistent output responses, in which the user ultimately has no choice but to abandon their previous emotional response or connection to the robot. As such, while the uncanny-response valley may be deep, the user will typically try to do what they can to hang onto the edge of valley and avoid falling in, and hopefully climb out, if the robot's output responses get back on track.

In order to avoid the uncanny-response valley, as the users emotional response 520 increases, it is advantageous to place a higher priority on not giving a wrong output response (avoiding Type 1 error/false positive), rather than simply giving the most probable output response.

For example, with natural language processing databases, these database will typically give a level of confidence that a particular answer is likely correct. However, it is typically advantageous to give a response with a lower Type 1 error then it is to give one with a higher degree of confidence.

In fact, often if the Type 1 error is above a predetermined threshold that the consistency of response would be below the uncanny response limit 530, then it is typically better that the robot give no output response or a facilitating responses (e.g. “go on”, “un-huh”, “really?”. “tell me more”, a head nod, a shoulder shrug . . . etc.), rather than risk getting the answer wrong. It should be noted that the uncanny response limit and/or the associated Type 1 threshold can be individualized per user, by the users perceived emotional state, by the robot's personality, by the robot's emotional state, and even based on interaction variables such as interaction subject matter, location of interaction, time of day, and even things like whether or not others are privy to the interaction.

Further, if the robot does detect that a wrong output response has likely been given such as the user hitting a button to indicate that they don't like an output response; a user asks a question such as “what do you mean?” or “why did you just say ______?”, or there is a sudden unanticipated change in emotional state of the user then, rather than trying to risk continuing down a pathway, the robot is better off issuing an apology for their inappropriate output responses and returning to the last known point of appropriate output response and then tying to re-engage the user at that point, rather to risk further communication decline.

However, in the event that the robot also has a personality then the no output response, facilitating responses, or the returning the last known point of appropriate output response can be enhanced through the use of taking into the account of the emotionality of the output response, which we refer to as “wagging the tail”.

The technique of “wagging the tail” refers to the fact that people have extended conversations with their pets; however, the average dog only understands about 150 words of human speech. What a dog does to keep the conversation going is it simply shows an appropriate emotional response (e.g. it wags its tail). When there is a high likelihood that type 1 error will occur then prioritizing simply giving an appropriate emotional response can help avoid the uncanny-response valley.

It is worth noting that for illustration purposes the uncanny response limit 530 was shown as being at 0.5. As previously stated, the uncanny response limit 530 is not necessarily the same for every individual nor is it necessarily a fixed value and as previously discussed, it can vary rapidly with things like the user's mood (happy vs feeling sad/vulnerable). It is the point at which the consistency of response 500 produces a neutral emotional response 520. In practice, as the uncanny response limit 530 is unknowable, what we do is we treat the predicted confidence that the answer is correct as uncanny response limit 530 and we have found that a confidence score of less than 75% often leads to producing a drop in the emotional response 520 confidence. However, this limit is individualized as we learn more about the user.

Having described embodiments as a system, it is useful to describe associated methods. The methods comprise selecting an initial personality and emotional state and receiving one or more of physical or non-physical input, determine an emotional state to be tied to the output response and select and produce an output response associated with the determined emotional state and the current personality profile.

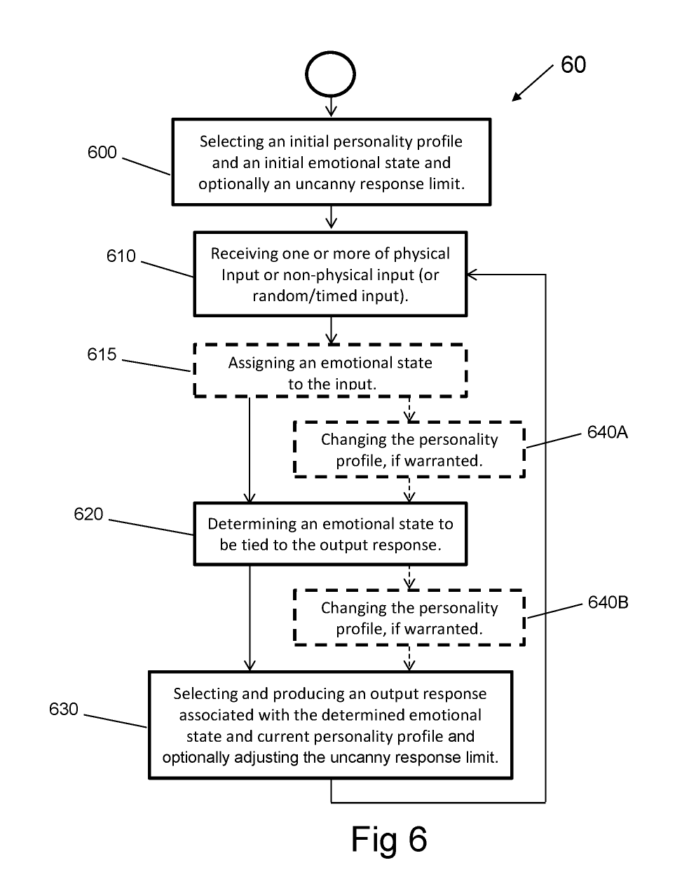

FIG. 6 shows, in simplified form, a method 60 consistent with the present embodiments. The method 60 comprises the following steps: selecting an initial personality and emotional state and optionally an uncanny response limit [Step 600], receiving one or more of physical or non-physical input (or optionally random/timed input) [Step 610], [Optionally] assigning an emotional state to the input [Step 615], determining an emotional state to be tied to the output response [Step 620] and selecting and producing an output response associated with the determined emotional state and the current personality profile and optionally adjusting the uncanny response limit [Step 630] and optionally, changing the personality profile, if warranted [Step 640A, 640B].

Selecting an initial personality and emotional state and optionally an uncanny response limit [Step 600] comprise selecting an emotional state from among at least two emotional states, as previously described and optionally an uncanny response limit.

With respect to receiving one or more of physical or non-physical input (or optionally random/timed input) [Step 610], aside from receiving one or more of physical or non-physical input, it is advantageous to also optionally include random input to create a more realistic conditions. For example, when the robot is in emotional state of sleeping, random input that initiates an output response of snoring creates a more realistic simulation. Timed input is particularly advantageous during the use of training where you may be waiting for an answer from a user that never comes.

The method 60 shows the optional step of assigning an emotional state to the input [Step 615], while not required to be a part of the method. It is advantageous to assign an emotional state to the input because assigning an emotional state to the input more accurately reflects normal human interaction. It is particularly valuable when used in conjunction with the uncanny response limit.

The method 60 also optionally includes changing the personality profile, if warranted [Step 640A, 640B]. Changing the personality profile can optionally be either before or after the step of determining an emotional state to be tied to the output response [Step 620]. If the personality profile is changed before the emotional state is determined then the personality profile can be used in determining the emotional state to be tied to the output response. For example, if the input received is so extreme then it might be more appropriate to change the personality profile before, rather than after, an emotional response has been tied to the output response. In other cases, for example when transitioning from one training state to another it may be more appropriate to change the personality state after the emotional state has been tied to the output state.

With respect to incorporating the training emotional states specified in FIG. 4 into FIG. 6, the pre-training 235-1 emotional state could be selected as part of selecting an initial personality and emotional state [Step 600] or part of determining an emotional state to be tied to the output response [Step 620], with the later likely being in response to receiving a verbal input form the user that they would like to be trained as part receiving one or more of physical or non-physical input (or optionally random/timed input) [Step 610].

Once the pre-training 235-1 mode (or any of the other training modes had been entered) the system would follow the steps outlined and ultimately selecting and producing an output response associated with the determined emotional state and the current personality profile [Step 630]. Then you would continue to cycle through the steps until one of either the input being received [Step 610] cause one of the following: a transition point to be reached, the input upper limit to be exceeded, or the input lower limit to be crossed. Once one of these events occurs, an appropriate emotional state to be tied to the output [Step 620] will be selected and optionally the personality profile, as previously discussed, might be changed [Step 640B] as well.

With respect to incorporating the uncanny response limit 530 specified in FIG. 5 into FIG. 6. The uncanny response limit 530 would typically be initially set-up as part of the initial step of selecting an initial personality and emotional state and optionally an uncanny response limit [Step 600] but could actually occur at any step of the process, particularly if you wanted to monitor the users input for a while before establishing the uncanny response limit. Similarly once established, it could be adjusted at any step. However, in practice, we have determined that is most logical to adjust it at the final step of selecting and producing an output response associated with the determined emotional state and the current personality profile [Step 630]. Once changed, then using this new uncanny response limit to monitor the input being received [Step 610].

The uncanny response limit, either the original or adjusted, would be used, as previously described in respect to FIG. 4, to ultimately influence the selecting and producing an output response associated with the determined emotional state and the current personality profile [Step 630].

Finally, it is to be understood that various different variants of the invention, including representative embodiments and extensions have been presented to assist in understanding the invention. It should be understood that such implementations are not to be considered limitations on either the invention or equivalents except to the extent they are expressly in the claims. It should therefore be understood that, for the convenience of the reader, the above description has only focused on a representative sample of all possible embodiments, a sample that teaches the principles of the invention. The description has not attempted to exhaustively enumerate all possible permutations, combinations or variations of the invention, since others will necessarily arise out of combining aspects of different variants described herein to form new variants, through the use of particular hardware or software, or through specific types of applications in which the invention can be used. That alternate embodiments may not have been presented for a specific portion of the description, or that further undescribed alternate or variant embodiments may be available for a portion of the invention, is not to be considered a disclaimer of those alternate or variant embodiments to the extent they also incorporate the minimum essential aspects of the invention, as claimed in the appended claims, or an equivalent thereof.

What is claimed:

1. An interaction training system comprising:
a robot with one or more processors capable of processing computer code;
one or more physical interaction interfaces configured to receive physical input;
one of more non-physical interaction interfaces configured to receive non-physical input;
one or more output systems configured to transmit a response; and
implemented within the computer code: at least two or more emotional states; one or more personality profiles, wherein each personality profile determines how the robot will respond to one or more of either the physical input or the non-physical input based on the robot's current emotional state;
and is configured to transition between the at least two or more emotional states;
wherein at least one of the emotional states is a first training state and wherein the first training state has a first upper and first lower input thresholds and a first predetermined training criteria; and
wherein the system is configured transition out of the first training state to another emotional state when one of the following occurs; the first upper input threshold is exceed, the input received drops below the first lower input threshold, the input has remained between the first upper and first lower threshold until the first predefined training criteria has been met.

2. The system of claim 1 wherein the system has at least two or more personalities and wherein the system is further configured to transition between the personalities.

3. The system of claim 2 where in the system is further configured to transition to transition between personalities when one or more of the following occurs the first upper input threshold is exceed, the input received drops below the first lower input threshold, the input has remained between the first upper and first lower threshold until the first predefined training criteria has been met.

4. The system of claim 1 further comprising:
at least three or more emotional states, wherein at least one of the three or more emotional states is a second training state;
wherein the system is further configured to transition from the first training state to the second training state when the first predefined training criteria has been met;
wherein the second training state has a second upper and second lower input thresholds and a second predetermined training criteria; and
wherein the system is configured to transition out of the second training state to another emotional state when one of the following occurs: the second upper input threshold is exceed, the input received drops below the second lower input threshold, the input has remained between the second upper and second lower threshold until the second predefined training criteria has been met.

5. The system of claim 4 wherein the system has at least two or more personalities and wherein the system is further configured is configured to transition between the personalities.

6. The system of claim 5 where in the system is further configured to transition to transition between personalities when one or more of the following occurs the first upper input threshold is exceed, the input received drops below the first lower input threshold, the input has remained between the first upper and first lower threshold until the first predefined training criteria has been met.

7. The system of claim 1 further comprising a predetermined uncanny response limit and the system is further configured to prioritize not being wrong the closer the user's perceived emotional response is to, or above, the uncanny response limit.

8. The system of claim 7 wherein the uncanny response limit is individualized per user.

9. The system of claim 7 wherein the system is configured to adjust the uncanny response limit from its predetermined value based upon user input.

10. The system of claim 1 wherein the predetermined training criteria is based upon adherence to a process flow.

11. The system of claim 1 wherein the predetermined training criteria has an idealized input curve and at least one the first upper and first lower input thresholds is configured to adjustable towards the idealized input curve as a user becomes more expert at accomplishing the predetermined training criteria.

12. The system of claim 1 wherein the robot is anthropomorphic.

13. The system of claim 1 wherein one of the one or more outputs is configured to produce one or more physical changes in the robot.

14. The system of claim 1 wherein the transition between the at least two emotional states is based upon time of day.

15. The system of claim 1 wherein the transition between the at least two or more emotional states is based upon length of time in current state.

16. The system of claim 1 wherein the transition between the at least two or more emotional states is based upon previous emotional state.

17. The system of claim 1 wherein at least one the first upper and first lower input thresholds is related to physical input.

18. The system of claim 1 wherein at least one the first upper and first lower input thresholds is related to non-physical input.

19. The system of claim 1 wherein the transition between the at least two or more emotional states is based upon probability.

20. The system of claim 20 wherein the probability is random.
